(19) United States
(12) Patent Application Publication
(10) Pub. No.: US 2015/0019125 A1
(43) Pub. Date: Jan. 15, 2015

(54) GPS NAVIGATION DIRECTIONS DISPLAY DEVICE, SYSTEM, AND PROCESS WITH POINTS OF INTEREST

(71) Applicant: EDUARD MAZANEC, Newark, CA (US)

(72) Inventor: EDUARD MAZANEC, Newark, CA (US)

(21) Appl. No.: 14/258,384

(22) Filed: Apr. 22, 2014

Related U.S. Application Data
(60) Provisional application No. 61/846,310, filed on Jul. 15, 2013.

(51) Int. Cl. G01C 21/36

(52) U.S. Cl. CPC G01C 21/3679; G01C 21/3682
USPC 701/410; 701/541; 701/533; 701/491

(57) ABSTRACT

Some embodiments include a navigational process for alerting a user of a portable navigational device of an upcoming point of interest. The navigational process may be implemented as a navigational software application that runs on the portable navigational device. In some embodiments, a wide-area global positioning system (GPS) provides navigational route information and points of interest information to the portable navigational device after the navigational process requests the navigational route information. In some embodiments, the wide-area GPS system retrieves the navigational route information from a map service. In some embodiments, the wide-area GPS system retrieves the points of interest information from a points of interest (POI) service.

### CLAIM OF BENEFIT TO PRIOR APPLICATION

This application claims benefit to U.S. Provisional Patent Application 61/846,310, entitled “GPS Navigation Directions Display With Points Of Interest,” filed Jul. 15, 2013. The U.S. Provisional Patent Application 61/846,310 is incorporated herein by reference.

### BACKGROUND

Embodiments of the invention described in this specification relate generally to directional mapping global positioning system (GPS) devices and applications, and more particularly, to enhanced directional mapping features of GPS devices and applications.

Conventional GPS devices and applications currently display the driving or navigation directions by presenting a direction/driving action (such as, next turn, go straight, etc.). These conventional directions/driving actions do not display any points of interest, either specific to the particular user of that GPS device (such as friends living on that street, favorite restaurants on that street, banks, stores, etc.) or potentially of general interest based on a user profile or matching of current points of interest with similar points of interest in the user's profile or advertisements related to that location. None of these points of interest are displayed in such a way as to permit the user to change his or her route, such as but not limited to providing points of interest that may be associated with the display of the next driving or navigation direction or action.

Therefore, improvements to conventional GPS and similar navigational devices and applications are desirable.

### BRIEF DESCRIPTION

Some embodiments of the invention include a novel navigational process for alerting a user of a portable navigational device of an upcoming point of interest. In some embodiments, the navigational process is implemented as a navigational software application that runs on the portable navigational device. In some embodiments, a wide-area GPS system provides navigational route information and points of interest information to the portable navigational device after the navigational process requests the navigational route information. In some embodiments, the wide-area GPS system retrieves the navigational route information from a map service. In some embodiments, the wide-area GPS system retrieves the points of interest information from a points of interest (POI) service.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a schematic view of a navigational device displaying a navigation map in some embodiments.

FIG. 2 conceptually illustrates an architecture of a wide-area GPS navigation system in some embodiments.

FIG. 3 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

I. GPS Navigation with Points of Interest

As stated above, a problem with current display of the direction/driving action (such as next turn, go straight, etc.) from a conventional GPS device or other mobile navigational device providing directions is that such devices do not display points of interest associated with the display of the next action in the directions of travel.

Some embodiments of the invention include a novel navigational process for alerting a user of a portable navigational device of an upcoming point of interest. In some embodiments, the navigational process is implemented as a navigational software application that runs on a novel portable navigational device that retrieves navigational route information and provides an alert when an upcoming point of interest is located along the route. In some embodiments, a novel navigational system provides navigational route information and points of interest information to the portable navigational device when the navigational software application requests the navigational route information. In some embodiments, the navigational system is a wide-area GPS navigation system. In some embodiments, the wide-area GPS system retrieves the navigational route information from a map service. In some embodiments, the wide-area GPS system retrieves the points of interest information from a points of interest (POI) service.

The navigational process, system, and device of the present application may be configured to identify, retrieve, and display points of interest. The points of interest include places such as, but not limited to, a favorite restaurant on a current or coming street, a house of a friend or relative along the route, a particular bank, service station, or commercial business on the current or coming street, etc. In some embodiments, the points of interest are displayed along with the display of the next direction/driving action on a navigational route provided by the navigational system and displayed on the navigational device by a navigational software application that implements the navigational process.

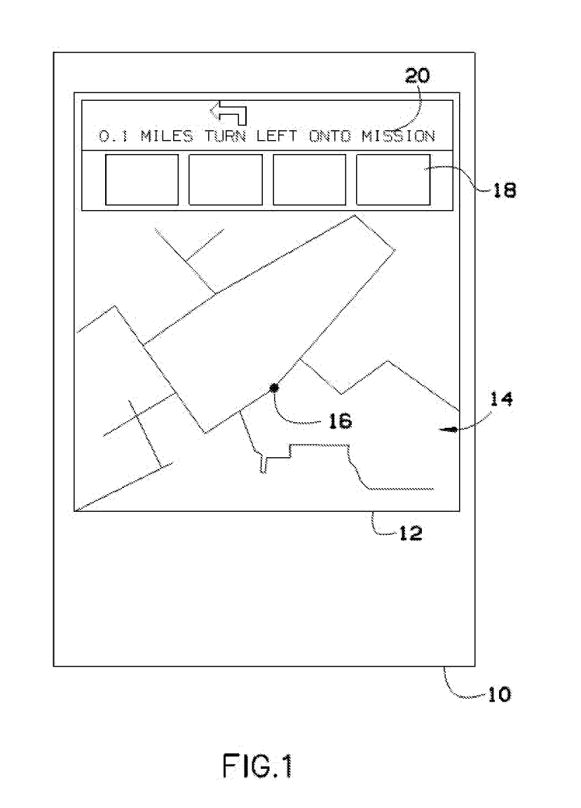

By way of example, FIG. 1 conceptually illustrates a schematic view of a navigational device displaying a navigation map in some embodiments. As shown in this figure, a mobile navigation device 10 may be a dedicated GPS device or a smart phone or tablet or similar portable device that may have a native or installed GPS application in board and GPS capable hardware. Device 10 may further be a mobile navigational device mounted or installed in a motor vehicle or other means of conveyance, or it may be a portable device that a user may carry with them as they change modes of transportation. Device 10 may preferable include a visual display 12. While the present device is described with regard to visual displays and presentation of instructions and information of interest, it is anticipated that the concept of the present application may be utilized in devices that have spoken or aural directions for travelers, or devices which may provide information and/or directions to users through non-visual displays. It is further anticipated that the device of the present disclosure may be adapted to provide information and/or alerts to a user via a combination of visual, audible or tactile means.

Illustrated on display 12 of the exemplary device 10 may be a map 14 with the user's current location 16 prominently displayed or indicated thereon. Along with the display of a set of directions 20 on display 12, there may also be a display of one or more points of interest 18 along or adjacent to the next upcoming segment of travel of the designated route being provided to the user. These points of interest 18 may include the following exemplary items, but it is not intended to limit points of interest 18 to this list: friends living on or near the segment of travel, favorite restaurants on or near that next segment, banks, stores, or other commercial establishments on or near that next segment, and advertising relating to such commercial points of interest. It is anticipated that device 10 may allow the user to set specific thresholds for distance from the designated route to filter the display of points of interest. It is anticipated that some more dynamic filtering techniques may be used based on the nature and speed of the user's conveyance (foot, bicycle, car, train, airplane, etc.) and/or the nature of the area through which the route is transiting (urban/suburban/rural environment, adjacent or intervening features, such as rivers or lakes, accessibility via the available road or other transit network, etc.).

Software may be operational on device 10 to provide the identification and display of points of interest. It is anticipated that this software may be native to the mobile navigation device 10 or may be an after-market or third party update, upgrade or download installed or selected by the user, with a plug-in to access points of interest data and information when such information is provided through a GPS navigation system with a points of interest (POI) service.

Individually, driving directions 20 may display or otherwise alert the user of an upcoming direction or action on display 12 of device 10. Software may identify relevant points of interest 18 based on the route and either specific information input to the device by the user (names and addresses of friends, associates, favorite businesses, etc.) or derived by the software based on classification or interpretation of the user's personal preference data or advertisement. Software of some embodiments will preferably cause display 12 to show appropriate points of interest on the upcoming street or road. Together the directions may guide the user to his or her destination as well as show the user's points of interest along the way.

Device 10 in some embodiments may include software as part of the native operational application that is programmed into the device 10 or software may be provided as an application for a mobile device would have to be developed or a website would have to be developed incorporating these features. Desirable elements of a navigational device 10 according to the present disclosure may include but are not limited to GPS receiver/transmitter, an operating system with sets of instructions that allow the navigational device 10 to send and receive data between the device 10 and a GPS satellite of a GPS navigation system server and directly between the device and the GPS navigation system server, a mobile device with suitable and sufficient on-board processing and/or data storage capacities, software associated with that device, access to user's input regarding his or her favorite places, friends, contacts, and/or points of interest. Optional elements that may be included in the device of the present application may be automatic display of point of interest in the form of a specific icon, photo image, or other appropriate visual image. If the user does not select or provide any points of interest, contacts, or favorite places, the device and/or software could display pre-programmed points of interest along the user's route.

To exploit the features of the portable navigational device 10 of some embodiments, a person may use the device within a navigational system, such as a wide-area GPS navigation system, to be automatically notified in real-time of points of interest along a navigation route provided by the navigational system without having to expressly search for or request the points of interest information. Additionally, the portable navigational device 10 of some embodiments can be implemented for use by a person in any sort of manner that allows the navigational device 10 to access a navigational system, including any sort of vehicle, such as cars and trucks, automated self-driving vehicles (e.g., so-called “driverless” vehicles), motorcycles and bicycles, or in non-motorized or moving vehicles, including in wearable computers (for walking pedestrians) or other similar devices.

In the next section, an example of a wide-area GPS navigation system is described. In some embodiments, the navigational device is in communication with the wide-area GPS navigation system in order to request location information of the navigational device and retrieve map and route information for a particular travel destination.

### II. GPS System Architecture

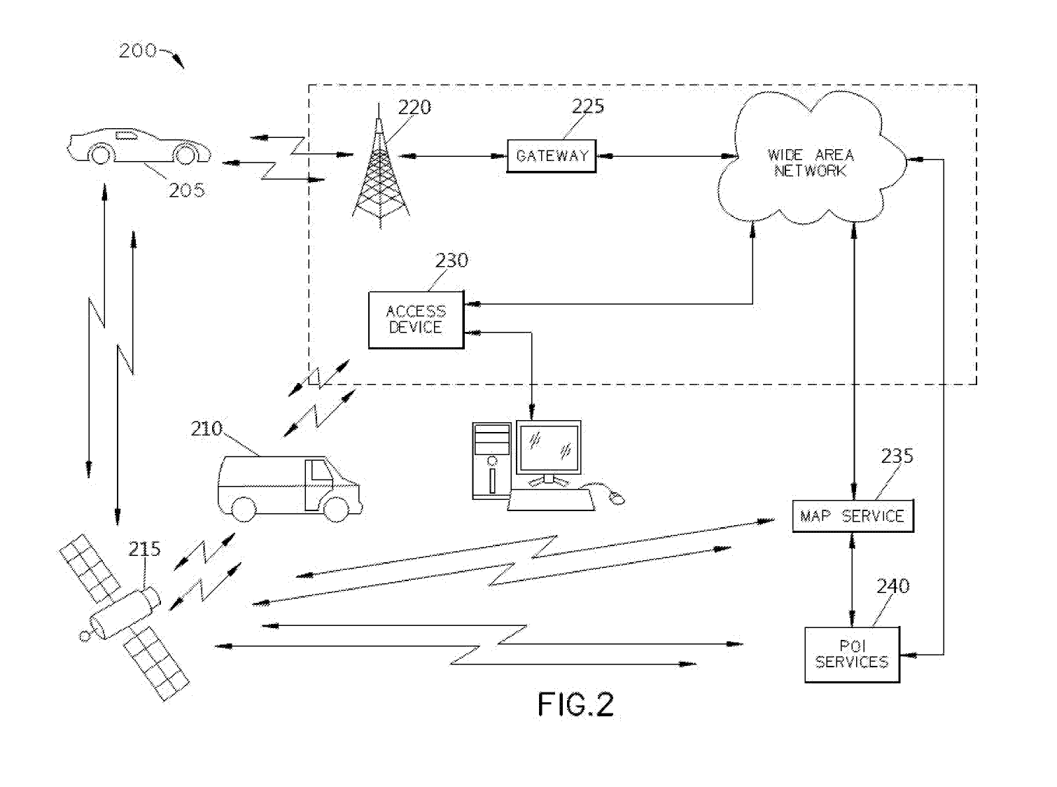

FIG. 2 conceptually illustrates an architecture of a wide-area GPS navigation system 200 in some embodiments. As shown in this figure, the wide-area GPS navigation system 200 includes a set of GPS navigation devices 205 and 210 that request and receive real-time location information from a GPS satellite 215 and display navigational maps and directions received from the wide-area GPS navigation system 200. In particular, the GPS navigation device 205 communicates with the wide-area GPS navigation system 200 through communication tower 220 and gateway 225, while the GPS navigation device 210 communicates with the wide-area GPS navigation system 200 by way of access device 230. A map service 235 provides map data to the wide area GPS system 200 and in some cases includes additional points of interest information from the POI service 240 with the map data. The POI service 240 can also provide points of interest data directly to the wide-area GPS navigation system 200 without communicating with map service 235.

In some embodiments, enhanced maps and directions with points of interest information are provided to navigation devices 205 and 210 when the navigation devices request route information from the wide-area GPS navigation system 200. For example, navigation device 205 may enter a destination address in an operating GPS device which is requesting and receiving real-time location data from satellite 215, and may thereby transmit a request for navigational directions and maps from the current location of the navigation device 205 (as received from satellite 215) to the input destination address. Upon receiving a request from a navigation device, the wide-area GPS navigation system 200 transmits the current location information and the destination address to the map service 235. In some embodiments, the transmission to the map service 235 includes a request for points of interest to be included. The map service then requests the points of interest data from the POI service 240 according to a route generated for the requested navigation map. In some embodiments, the wide-area GPS navigation system 200 requests a map from the map service 235 and, after receiving the navigation map from the map service 235, requests points of interest information from the POI service 240. In these embodiments, the wide-area GPS navigation system 200 transmits one or more of the rendered map data (i.e., the navigation map received from the map service 235), the route directions, and both the map and route directions. In this way, the POI service 240 is able to identify the points of interest along the navigation route.

While the example wide-area GPS navigation system 200 described above by reference to FIG. 2 is one type of navigational system in which a navigational device running the navigational software application can request and receive real-time points of interest information along a particular map route, a person skilled in the art would understand there to be other types of navigational systems that can provide such points of interest information to the navigational device.

### III. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

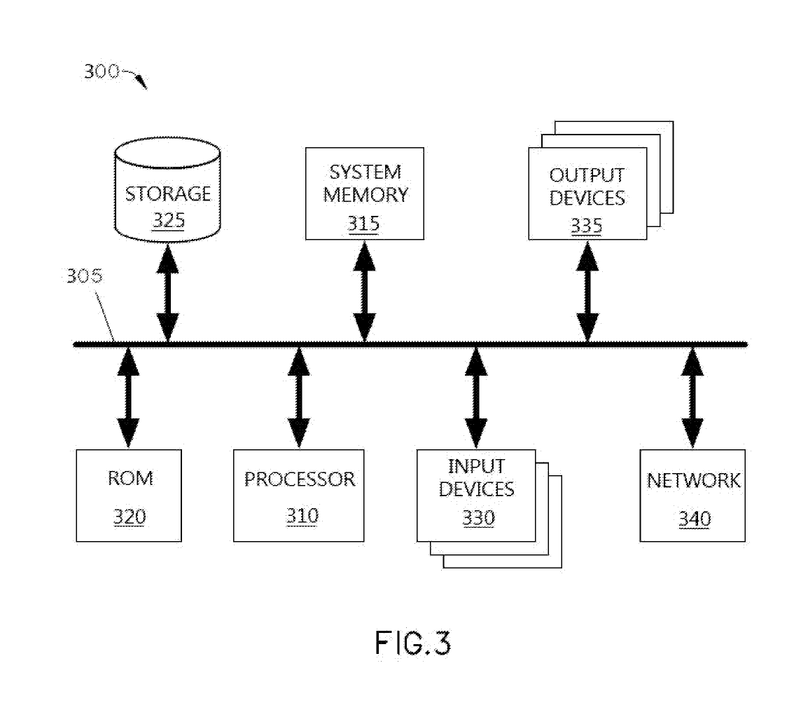

FIG. 3 conceptually illustrates an electronic system 300 with which some embodiments of the invention are implemented. The electronic system 300 may be a computing device, such as a desktop computer, a laptop computer, a tablet computing device, a portable hand-held computing device, a portable communications devices (such as a mobile phone), a personal digital assistant (PDA) computing device, or any other sort of electronic device. Such an electronic system includes various types of computer readable media and interfaces for various other types of computer readable media. Electronic system 300 includes a bus 305, processing unit(s) 310, a system memory 315, a read-only 320, a permanent storage device 325, input devices 330, output devices 335, and a network 340.

The bus 305 collectively represents all system, peripheral, and chipset buses that communicatively connect the numerous internal devices of the electronic system 300. For instance, the bus 305 communicatively connects the processing unit(s) 310 with the read-only 320, the system memory 315, and the permanent storage device 325.

From these various memory units, the processing unit(s) 310 retrieves instructions to execute and data to process in order to execute the processes of the invention. The processing unit(s) may be a single processor or a multi-core processor in different embodiments.

The read-only-memory (ROM) 320 stores static data and instructions that are needed by the processing unit(s) 310 and other modules of the electronic system. The permanent storage device 325, on the other hand, is a read-and-write memory device. This device is a non-volatile memory unit that stores instructions and data even when the electronic system 300 is off. Some embodiments of the invention use a mass-storage device (such as a magnetic or optical disk and its corresponding disk drive) as the permanent storage device 325.

Other embodiments use a removable storage device (such as a floppy disk or a flash drive) as the permanent storage device 325. Like the permanent storage device 325, the system memory 315 is a read-and-write memory device. However, unlike storage device 325, the system memory 315 is a volatile read-and-write memory, such as a random access memory. The system memory 315 stores some of the instructions and data that the processor needs at runtime. In some embodiments, the invention's processes are stored in the system memory 315, the permanent storage device 325, and/or the read-only 320. For example, the various memory units include instructions for processing appearance alterations of displayable characters in accordance with some embodiments. From these various memory units, the processing unit(s) 310 retrieves instructions to execute and data to process in order to execute the processes of some embodiments.

The bus 305 also connects to the input and output devices 330 and 335. The input devices enable the user to communicate information and select commands to the electronic system. The input devices 330 include alphanumeric keyboards and pointing devices (also called “cursor control devices”). The output devices 335 display images generated by the electronic system 300. The output devices 335 include printers and display devices, such as cathode ray tubes (CRT) or liquid crystal displays (LCD). Some embodiments include devices such as a touchscreen that functions as both input and output devices.

Finally, as shown in FIG. 3, bus 305 also couples electronic system 300 to a network 340 through a network adapter (not shown). In this manner, the computer can be a part of a network of computers (such as a local area network (“LAN”), a wide area network (“WAN”), or an Intranet), or a network of networks (such as the Internet). Any or all components of electronic system 300 may be used in conjunction with the invention.

The functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, processes may be performed by the navigational software application and servers in the wide-area GPS navigation system. The specific operations of these processes may not be performed in the exact order shown and described. Specific operations may not be performed in one continuous series of operations, and different specific operations may be performed in different embodiments. Furthermore, the processes could be implemented using several sub-processes, or as part of larger macro processes. Thus, one of ordinary skill in the art would understand that the invention is not to be limited by the foregoing illustrative details and examples, but rather is to be defined by the appended claims.

I claim:

1. A mobile navigational system comprising:
a mobile computing device comprising a processor, a memory unit, a display screen, and a communication transceiver, said mobile computing device configured to display on the display screen a set of navigational instructions along a route that traverses from a starting location to a destination location; and
a navigational software application installed on the mobile computing device, wherein the navigational software application comprises sets of instructions for (i) identifying a set of points of interest at a set of corresponding locations along the route and (ii) displaying the identified points of interest on the display screen, wherein each identified point of interest is displayed at the corresponding location along the route that is proximate to a navigational instruction along the route.

2. The mobile navigational system of claim 1 further comprising a map service that provides a set of route points to the mobile computing device for the route.

3. The mobile navigational system of claim 2, wherein the set of route points comprises the set of locations corresponding to the set of points of interest along the route.

4. The mobile navigational system of claim 2 further comprising a POI service that provides the set of points of interest to the mobile computing device for the route.

5. The mobile navigational system of claim 4, wherein the navigational software application further comprises a set of instructions for matching the locations corresponding to the points of interest provided by the POI service to route points in the set of route points provided by the map service.

6. A mobile navigational computing device that is configured to display points of interest along a route in real time as a set of navigational information is displayed by the computing device along the route, said mobile navigational computing device comprising:
a central processing unit (CPU);
a memory unit;
a display screen;
a communication transceiver; and
a storage unit that stores a program which when executed on the CPU (i) uses the communication transceiver to receive current location information from a GPS satellite of a GPS navigation system, (ii) requests the GPS navigation system to provide navigational directions from the current location to a second location, (iii) receives, from the GPS navigation system, route information from the current location to the second location, (iv) receives, from the GPS navigation system, a set of points of interests proximate to the route, and (v) displays the route and the points of interest on the display screen.

7. The mobile navigational computing device of claim 6 further comprising a graphics processing unit (GPU) that renders a display image update of the route and the points of interest that is displayed on the display screen, each updated display image rendered when the mobile computing device receives an updated current location from the GPS satellite of the GPS navigation system.

8. The mobile navigational computing device of claim 6, wherein the program further displays a set of navigational instructions in text format which corresponds to the route displayed on the display screen.

9. A non-transitory computer readable medium storing a navigation software application which when executed by at least one processing unit of a mobile computing device displays a route map in real-time as a vehicle moves from a first location to a second location, said program comprising sets of instructions for:
requesting a current location of the vehicle;
receiving location data for the current location of the vehicle from a GPS satellite of a GPS navigation system;
associating the first location with the current location;
sending a request to the GPS navigation system for map instructions of the route between the first location and the second location;
receiving, from the GPS navigation system, map instructions of the route and a set of points of interest along the route; and
displaying a map of the route and the points of interest along the route.

10. The non-transitory computer readable medium of claim 9, wherein the set of instructions for displaying the points of interest along the route comprise a set of instructions for retrieving a set of pre-configured points of interest in the GPS navigation system, said pre-configured points of interest set by a user of the mobile computing device.
